(19) United States
(12) Patent Application Publication
(10) Pub. No.: US 2013/0290108 A1
(43) Pub. Date: Oct. 31, 2013

(54) SELECTION OF TARGETED CONTENT BASED ON RELATIONSHIPS

(71) Applicants: Leonardo Alves Machado, Porto Alegre Rio Grande Do Sul (BR); Somma Sundaram Santhiveeran, Fremont, CA (US); Diogo Strube de Lima, Porto Alegre Rio Grande Do Sul (BR); Walter Flores Pereira, Porto Alegre (BR)

(72) Inventors: Leonardo Alves Machado, Porto Alegre Rio Grande Do Sul (BR); Somma Sundaram Santhiveeran, Fremont, CA (US); Diogo Strube de Lima, Porto Alegre Rio Grande Do Sul (BR); Walter Flores Pereira, Porto Alegre (BR)

(21) Appl. No.: 13/456,391

(22) Filed: Apr. 26, 2012

(51) Int. Cl. G06Q 30/02

(52) U.S. Cl. 705/14.66

(57) ABSTRACT

Techniques for selecting a targeted content item for playback are described in various implementations. A method that implements the techniques may include receiving, at a computer system and from an image capture device, an image that includes a plurality of potential users of a presentation device. The method may also include processing the image, using the computer system, to determine an indication of a relationship between two or more of the plurality of potential users. The method may further include selecting, using the computer system, a targeted content item for playback on the presentation device based on the indication of the relationship.

### BACKGROUND

Advertising is a tool for marketing goods and services, attracting customer patronage, or otherwise communicating a message to an audience. Advertisements are typically presented through various types of media including, for example, television, radio, print, billboard (or other outdoor signage), Internet, digital signage, mobile device screens, and the like.

Digital signs, such as LED, LCD, plasma, and projected images, can be found in public and private environments, such as retail stores, corporate campuses, and other locations. The components of a typical digital signage installation may include one or more display screens, one or more media players, and a content management server. Sometimes two or more of these components may be combined into a single device, but typical installations generally include a separate display screen, media player, and content management server connected to the media player over a private network.

Regardless of how advertising media is presented, whether via a digital sign or other mechanisms, advertisements are typically presented with the intention of commanding the attention of the audience and to induce prospective customers to purchase the advertised goods or services, or otherwise be receptive to the message being conveyed.

### BRIEF DESCRIPTION OF THE DRAWINGS

FIG. 1 is a conceptual diagram of an example digital display system.

FIG. 2 is a block diagram of an example system for providing targeted content based on relationships.

FIG. 3 is a flow diagram of an example process for selecting targeted content based on relationships.

FIG. 4 is a flow diagram of an example process for selecting targeted content based on relationships.

### DETAILED DESCRIPTION

Traditional mass advertising, including digital signage advertising, is a non-selective medium. As a consequence, it may be difficult to reach a precisely defined market segment. The volatility of the market segment, especially with placement of digital signs in public settings, is heightened due to the changing variations in the composition of audiences. In many circumstances, the content may be selected and delivered for display on a digital sign based on a general understanding of the consumer tendencies considering time of day, geographic coverage, or the like.

According to the techniques described here, targeted content may be selected for presentation, e.g., on a display of a digital signage installation, based in part on the relationships between potential users of the display. In some implementations, an image capture device may capture an image that includes potential users of the display (e.g., individuals in the vicinity of the display who may potentially be interested in viewing content shown on the display), and the image may be transmitted to a content computer. For example, a video camera may be positioned near a display to capture an audience of one or more individuals located in the vicinity of the display (e.g., individuals directly in front of the display, or within viewing distance and/or earshot of the display, etc.), and may provide a still image or a set of one or more frames of video to the content computer for analysis. The content computer may process the image to determine an indication of a relationship between two or more of the potential users. For example, if the image includes an adult male in close proximity to an adult female who is holding a small child, the content computer may determine that the three individuals are a family, and that the two adults are a couple. At the same time, if another adult male is also included in the image, but is standing apart from the family and is not interacting with the family, the content computer may determine that the other adult male is not a part of the family group, but may be a part of a different group. The content computer may then select a targeted content item for playback on the display based on the indication of the relationship. For example, continuing with the example above, an advertisement for a family-friendly restaurant may be selected for display to the family; or, a different content item that is targeted to the other adult male may be selected based on the group information associated with the other adult male.

In some cases, the use of relationships associated with the potential viewers of a digital signage installation in such a manner may provide an improved understanding of the audience profile without storing any personal data about the potential viewers. The improved understanding of the audience profile may allow more relevant content to be displayed to the audience, which in turn may lead to increased user engagement with the digital sign, increased return on investment for operators of the digital sign, and/or increased usability of the digital sign. These and other possible benefits and advantages will be apparent from the figures and from the description that follows.

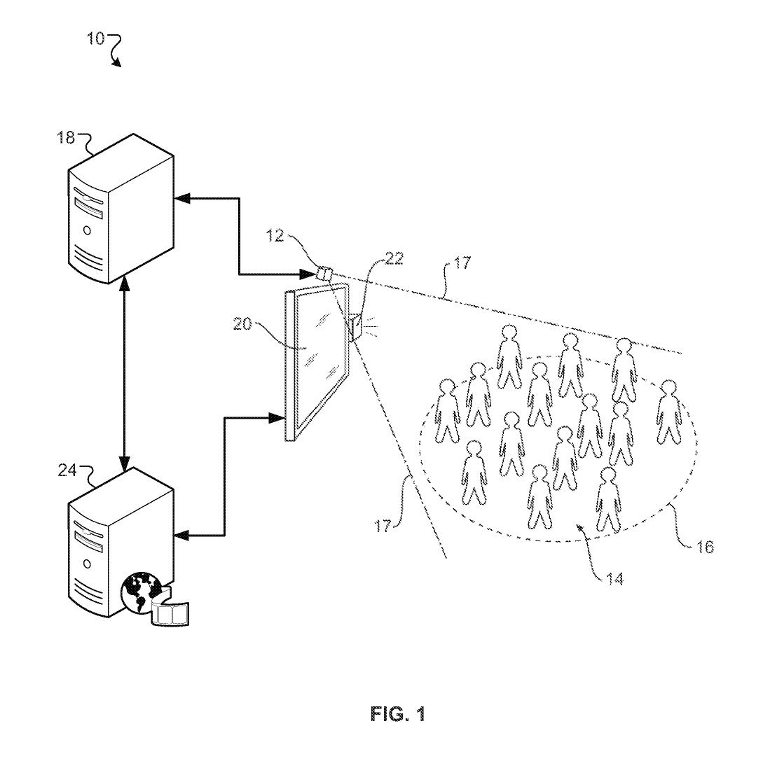

FIG. 1 is a conceptual diagram of an example digital display system 10. The system includes at least one imaging device 12 (e.g., a camera) pointed at an audience 14 (located in an audience area indicated by outline 16 that represents at least a portion of the field of view of the imaging device), and a content computer 18, which may be communicatively coupled to the imaging device 12 and configured to select targeted content for users of the digital display system 10.

The content computer 18 may include image analysis functionality, and may be configured to analyze visual images taken by the imaging device 12. The term “computer” as used here should be considered broadly as referring to a personal computer, a portable computer, an embedded computer, a content server, a network PC, a personal digital assistant (PDA), a smartphone, a cellular telephone, or any other appropriate computing device that is capable of performing functions for receiving input from and/or providing control for driving output to the various devices associated with an interactive display system.

Imaging device 12 may be configured to capture video images (i.e. a series of sequential video frames) at any desired frame rate, or to take still images, or both. The imaging device 12 may be a still camera, a video camera, or other appropriate type of device that is capable of capturing images. Imaging device 12 may be positioned near a changeable display device 20, such as a CRT, LCD screen, plasma display, LED display, display wall, projection display (front or rear projection), or any other appropriate type of display device. For example, in a digital signage application, the display device 20 can be a small or large size public display, and can be a single display, or multiple individual displays that are combined together to provide a single composite image in a tiled display. The display may also include one or more projected images that can be tiled together or combined or superimposed in various ways to create a display. An audio output device, such as an audio speaker 22, may also be positioned near the display, or integrated with the display, to broadcast audio content along with the visual content provided on the display.

The digital display system 10 also includes a display computer 24 that is communicatively coupled to the display device 20 and/or the audio speaker 22 to provide the desired video and/or audio for presentation. The content computer 18 is communicatively coupled to the display computer 24, allowing feedback and analysis from the content computer 18 to be used by the display computer 24. The content computer 18 and/or the display computer 24 may also provide feedback to a video camera controller (not shown) that may issue appropriate commands to the imaging device 12 for changing the focus, zoom, field of view, and/or physical orientation of the device (e.g. pan, tilt, roll), if the mechanisms to do so are implemented in the imaging device 12.

In some implementations, a single computer may be used to control both the imaging device 12 and the display device 20. For example, the single computer may be configured to handle all functions of video image analysis, content selection, and control of the imaging device, as well as controlling output to the display. In other implementations, the functionality described here may be implemented by different or additional components, or the components may be connected in a different manner than is shown. Additionally, the digital display system 10 can be a network, a part of a network, or can be interconnected to a network. The network can be a local area network (LAN), or any other appropriate type of computer network, including a web of interconnected computers and computer networks, such as the Internet.

The content computer 18 can be any appropriate type of computing device, such as a device that includes a processing unit, a system memory, and a system bus that couples the processing unit to the various components of the computing device. The processing unit may include one or more processors, each of which may be in the form of any one of various commercially available processors. Generally, the processors may receive instructions and data from a read-only memory and/or a random access memory. The computing device may also include a hard drive, a floppy drive, and/or a CD-ROM drive that are connected to the system bus by respective interfaces. The hard drive, floppy drive, and/or CD-ROM drive may access respective non-transitory computer-readable media that provide non-volatile or persistent storage for data, data structures, and computer-executable instructions to perform portions of the functionality described here. Other computer-readable storage devices (e.g., magnetic tape drives, flash memory devices, digital versatile disks, or the like) may also be used with the content computer 18.

The imaging device 12 may be oriented toward an audience 14 of individual people, who are gathered in an audience area, designated by outline 16. While the audience area is shown as a definite outline having a particular shape, this is intended to represent that there is some appropriate area in which an audience can be viewed. The audience area can be of a variety of shapes, and can comprise the entirety of the field of view 17 of the imaging device, or some portion of the field of view. For example, some individuals can be near the audience area and perhaps even within the field of view of the imaging device, and yet not be within the audience area that will be analyzed by the content computer 18.

In operation, the imaging device 12 captures an image of the audience, which may involve capturing a single snapshot or a series of frames (e.g., in a video). Imaging device 12 may capture a view of the entire field of view, or a portion of the field of view (e.g. a physical region, black/white vs. color, etc). Additionally, it should be understood that additional imaging devices (not shown) can also be used, e.g., simultaneously, to capture images for processing. The image (or images) of the audience may then be transmitted to the content computer 18 for processing.

Content computer 18 may receive the image or images (e.g., the audience view from imaging device 12 and/or one or more other views), and may process the image(s) to identify one or more distinct audience members included in the image. Content computer 18 may use any appropriate face or object detection methodology to identify distinct individuals captured in the image.

Content computer 18 may then determine an indication of a relationship between two or more of the audience members. For example, in some implementations the content computer 18 may initially focus on one of the audience members and determine whether that audience member is related (e.g., socially) to any of the other audience members, and may process other individual audience members in a similar manner until some or all of the possible relationships between audience members have been identified.

Content computer 18 may analyze a number of different factors, either alone or in appropriate combinations, to determine whether a relationship exists (or is likely to exist) between two or more members of the audience. Some examples of the different factors may include age, gender, ethnicity, body type, clothing, physical proximity to one another, the number of times the same individuals have been seen together (e.g., by the same or different cameras), and/or the level of engagement between the individuals.

Such factors, and others, may be used as inputs to a relationship analyzer that may be implemented with a rule set that defines what effect, if any, a particular factor or set of factors has on the determination of whether a relationship exists between individuals, and if so, what type of relationship it is likely to be. The rule set may be configurable, and may include weightings that allow an administrator to fine-tune the relationship analyzer, e.g., according to cultural or social norms in the area where the digital signage installation is to be located, or according to known models that provide an effective determination of relationships in a given context.

In some implementations, content computer 18 may determine that a relationship exists (or is likely to exist) based in part on whether a personal attribute associated with one of the audience members is shared with or is complementary to a corresponding personal attribute associated with another of the audience members. For example, a couple-type relationship may be determined to exist between a middle-aged man (gender attribute=male; age attribute=40) and a middle-aged woman (gender attribute=female; age attribute=40). In this example the man and woman share a common age attribute, and their gender attributes may be considered to be complementary. On the other hand, if the man and the woman are not standing near one another, and do not show any level of engagement, and have never been seen before in a single image, such evidence may be counter-indicative of a couple-type relationship, so other factors may also be considered in conjunction with the personal attribute factors to provide a more robust analysis.

As described above, such personal attribute rules may be configurable to account for cultural or social norms in the area where the system is located. For example, age differences seen in couples may vary by location such that a sixty-five year old man and a forty year old woman may be considered as a likely couple in some locations, but may be considered as a likely father and daughter in other locations. As another example, in some cultures, individuals having different ethnicities may be considered as a counter-indicator for a couple-type relationship, while in other cultures, such relationships may be the norm, and may therefore not have any positive or negative effect on a couple-type relationship determination. These examples are provided for explanatory purposes, but it should be understood that other appropriate personal attribute rules may be implemented in a given system.

In some implementations, content computer 18 may determine that a relationship exists (or is likely to exist) based in part on the physical distance between a body part of one of the audience members and a corresponding body part of another of the audience members. For example, if two individuals' hips or faces are relatively close together (e.g., within nine inches of one another), it may be considered likely that the individuals have a relationship because strangers may be unlikely to stand so closely to one another.

Such physical distance rules may be configurable to account for the location of the system and other appropriate factors, such as the typical foot traffic near the system. For example, in some cultures, the distance between individuals that may be considered to be indicative of a relationship may be increased or decreased based on cultural norms (e.g., “personal space” norms). As another example, if the system typically experiences heavy foot traffic, individuals are likely to be closer together even if a relationship does not exist between them, and the physical distance indicating a relationship may consequently be reduced. These examples are provided for explanatory purposes, but it should be understood that other appropriate physical distance rules may be implemented in a given system.

Based on the relationship determinations from the relationship analyzer, content computer 18 may then select a targeted content item (e.g., from a set of available content items) for playback. In some implementations, content computer 18 may compare the indication of the relationship to targeting criteria associated with various available content items to generate a comparison result, and may select the targeted content item based on the comparison result. For example, if the collection of available content items includes some advertisements that have been marked or otherwise targeted as being relevant to couples and other advertisements that are targeted towards co-workers, for instance, an advertisement that is marked as being relevant to co-workers may be selected when a co-worker-type relationship is detected.

Content computer 18 may also base the selection of a targeted content item on one or more extrinsic attributes (e.g., attributes that are not ascertainable from the image). In some implementations, extrinsic attributes may include, for example, a time of day, a date, a location of the system, and/or an environmental parameter (e.g., weather conditions). For example, content computer 18 may consider the current date when selecting content such as gift advertisements, and may select an advertisement for a necktie available at a nearby men's clothing store if the system detects a family relationship (e.g., a mother and two children) in the days leading up to Father's Day.

Content computer 18 may then either provide the selected content to the display device 20 directly or via display computer 24. The display device 20 (and in some cases the audio speaker 22) may then present the selected content to the audience members (i.e., users of the display device 20). The content may be digital, multimedia content which can be in the form of commercial advertisements, entertainment, political advertisements, survey questions, or any other appropriate type of content.

Content computer 18 may also store the indication of the relationship for later use. In some implementations, the system may include a data store for storing the relationship information in association with each of the individuals who form the relationship. For example, the system may detect a family relationship between a man, a woman, and two children, and may store an indication that the man is related to the woman in a family-type relationship and/or a couple-type relationship, and to each of the two children in a family-type, a parent-type, and/or a father-type relationship. Similarly, the system may store an indication that the woman is related to the man in a family-type relationship and/or a couple-type relationship, and to each of the two children in a family-type, a parent-type, and/or a mother-type relationship.

Such stored relationships may be used, for example when the system later detects one or more of the individuals in the family, to provide targeted content to the detected individuals. Continuing with the example above, if the mother and the two children are detected at a later date, e.g., in proximity to the display, but the father is not present on that occasion, the system may retrieve the stored indication of the individuals' respective relationships with the father. The system may then select targeted content for the mother and two children based on the stored indication that identifies their relationship with the father—e.g., by selecting an advertisement for a Father's Day gift from a nearby store. In some cases, the targeted content that is selected based on the stored indication (e.g., when the father is not at the store) may be different from targeted content that may have been selected when the father was at the store.

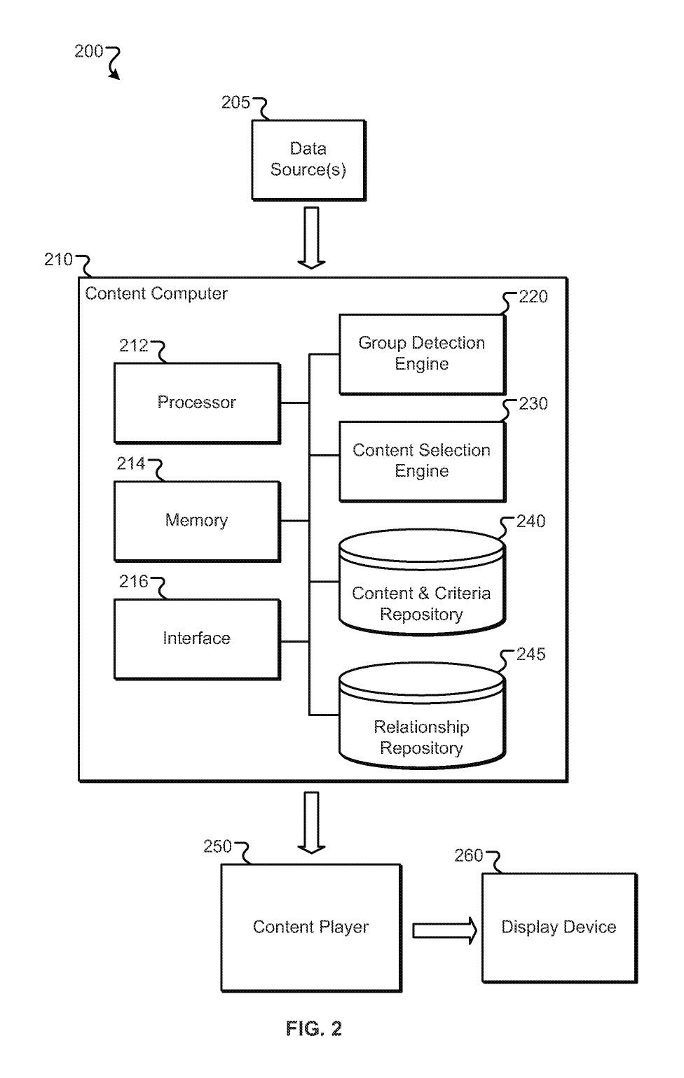

FIG. 2 is a block diagram of an example system 200 for providing targeted content based on relationships (e.g., groups to which an individual belongs). System 200 includes one or more data source(s) 205 communicatively coupled to content computer 210. The one or more data source(s) 205 may provide one or more inputs to content computer 210. The content computer 210 may be configured to select content for playback based on the one or more inputs, and to provide the selected content to content player 250 for playback on display 260.

Data source(s) 205 may include, for example, an image capture device (e.g., a camera) or an application that provides an image to the content computer 210. As used here, an image is understood to include a snapshot, a frame or series of frames (e.g., one or more video frames), a video stream, or other appropriate type of image or set of images. In some implementations, multiple image capture devices or applications may be used to provide images to content computer 210 for analysis. For example, multiple cameras may be used to provide images that capture different angles of a specific location (e.g., multiple views of an audience in front of a display), or different locations that are of interest to the system 200 (e.g., views of customers entering a store where the display is located).

Data source(s) 205 may also include an extrinsic attribute detector to provide extrinsic attributes to content computer 210. Such extrinsic attributes may include features that are extrinsic to the audience members themselves, such as the context or immediate physical surroundings of a display system. Extrinsic attributes may include time of day, date, holiday periods, a location of the presentation device, or the like. For example, a location attribute (children's section, women's section, men's section, main entryway, etc.) may specify the placement or location (e.g., geo-location) of the display 260, e.g., within a store or other space. Another example of an extrinsic attribute is an environmental parameter (e.g., temperature or weather conditions, etc.). In some implementations, the extrinsic attribute detector may include an environmental sensor and/or a service (e.g., a web service or cloud-based service) that provides environmental information including, e.g., local weather conditions or other environmental parameters, to content computer 210.

As shown, content computer 210 may include a processor 212, a memory 214, an interface 216, a group detection engine 220, a content selection engine 230, a content and criteria repository 240, and a relationship repository 245. It should be understood that these components are shown for illustrative purposes only, and that in some cases, the functionality being described with respect to a particular component may be performed by one or more different or additional components. Similarly, it should be understood that portions or all of the functionality may be combined into fewer components than are shown.

Processor 212 may be configured to process instructions for execution by the content computer 210. The instructions may be stored on a non-transitory tangible computer-readable storage medium, such as in main memory 214, on a separate storage device (not shown), or on any other type of volatile or non-volatile memory that stores instructions to cause a programmable processor to perform the functionality described herein. Alternatively or additionally, content computer 210 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the functionality described herein. In some implementations, multiple processors may be used, as appropriate, along with multiple memories and/or different or similar types of memory.

Interface 216 may be used to issue and receive various signals or commands associated with content computer 210. Interface 216 may be implemented in hardware and/or software, and may be configured, for example, to receive various inputs from data source(s) 205 and to issue commands to content player 250. In some implementations, interface 216 may be configured to issue commands directly to display device 260, e.g., for playing back selected content without the use of a separate content player. Interface 216 may also provide a user interface for interaction with a user, such as a system administrator. For example, the user interface may provide an input that allows a system administrator to control weightings or other rules associated with fine-tuning the parameters used to determine whether a relationship exists between one or more individuals (e.g., based on social or cultural norms in a particular location).

Group detection engine 220 may execute on processor 212, and may be configured to determine group information, e.g., based on the inputs received from data source(s) 205, such as an image received from an image capture device. The group information may include, for example, an indication of a relationship between a potential viewer of display device 260 and one or more other individuals included in the image.

Group detection engine 220 may implement facial detection and recognition techniques to detect distinct faces included in an image. The facial detection and recognition techniques may determine boundaries of a detected face, such as by generating a bounding rectangle (or other appropriate boundary), and may analyze various facial features, such as the size and shape of an individual's mouth, eyes, nose, cheekbones, and/or jaw, to generate a digital signature that uniquely identifies the individual to the system without storing any personally-identifiable information about the individual. In some implementations, group detection engine 220 may initially focus on one of the individuals in the image and determine whether that individual belongs to a group with any of the other individuals, and may process other individuals in a similar manner until some or all of the possible relationships between the individuals in the image have been identified.

Group detection engine 220 may analyze a number of different factors, either alone or in appropriate combinations, to determine whether a group relationship exists (or is likely to exist) between two or more individuals. Some examples of the different factors may include age, gender, ethnicity, body type, clothing, physical proximity to one another, the number of times the same individuals have been seen together (e.g., by the same or different cameras), and/or the level of engagement between the individuals. Such factors, and others, may be used as inputs to a rule set that defines what effect, if any, a particular factor or set of factors has on the determination of whether a group relationship exists between individuals, and if so, what type of relationship it is likely to be. The rule set may be configurable, and may include weightings that allow fine tuning, e.g., according to models that provide an effective determination of relationships in a given context.

In some implementations, group detection engine 220 may determine that a group relationship exists (or is likely to exist) based in part on whether a personal attribute associated with one of the individuals in the image is shared with or is complementary to a corresponding personal attribute associated with another individual in the image. In some implementations, group detection engine 220 may determine that a group relationship exists (or is likely to exist) based in part on the physical distance between a body part of one of the individuals in the image and a corresponding body part of another of the individuals. Other appropriate factors or parameters may also be considered in conjunction with the personal attribute factors and/or the physical distance parameters to determine whether a group relationship exists.

In some cases, the determination of a group relationship may be expressed in terms of a probability that two or more individuals are members of a particular group, and the probability may be updated over time as additional information is received. For example, if group detection engine 220 identifies additional factors that are considered to be consistent with a group relationship that has already been identified, the probability may be increased by an appropriate amount. Similarly, if group detection engine 220 identifies factors that are counter-indicative of a group relationship, the probability may be decreased.

Content selection engine 230 may execute on processor 212, and may be configured to select targeted content (e.g., from a set of available content items) for display on display device 260 based on the group information determined by group detection engine 220. In some implementations, content selection engine 230 may compare the group information to targeting criteria associated with various available content items to generate a comparison result, and may select the targeted content based on the comparison result. Content selection engine 230 may also base the selection of targeted content on one or more extrinsic attributes, including, for example, a time of day, a date, a location of the system, and/or an environmental parameter (e.g., weather conditions).

Content and criteria repository 240 may be communicatively coupled to the content selection engine 230, and may be configured to store content (e.g., content that is ultimately rendered to an end user) using any of various known digital file formats and compression methodologies. Content and criteria repository 240 may also be configured to store targeting criteria associated with each of the content items. As used here, the targeting criteria (e.g., a set of keywords, a set of topics, query statement, etc.) may include a set of one or more rules (e.g., conditions or constraints) that set out the circumstances under which the specific content item will be selected or excluded from selection. For example, a particular content item may be associated with one or more group relationships, and if group detection engine 220 detects one or more individuals who are members of a group to which the content item is targeted, the content selection engine 230 may select the content item for display via display device 260.

Relationship repository 245 may be communicatively coupled to group detection engine 220 and content selection engine 230, and may be configured to store the group information that has been detected by group detection engine 220. In some implementations, relationship repository may store the group information in association with each of the individuals who are a part of a particular group. The stored group information may be used, for example, when the content computer 210 later detects one or more of the individuals in a group in proximity to display device 260, to select and provide targeted content to the detected individuals.

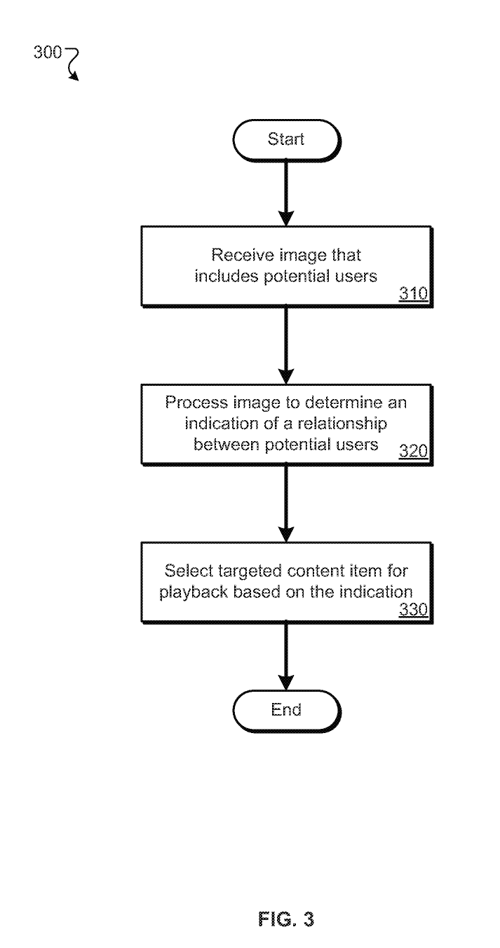

FIG. 3 is a flow diagram of an example process 300 for selecting targeted content based on relationships. The process 300 may be performed, for example, by a content computer such as the content computer 18 illustrated in FIG. 1. For clarity of presentation, the description that follows uses the content computer 18 illustrated in FIG. 1 as the basis of an example for describing the process. However, it should be understood that another system, or combination of systems, may be used to perform the process or various portions of the process.

Process 300 begins at block 310 when a computer system, such as content computer 18, receives an image that includes potential users of a presentation device. The image may be received from an image capture device, such as a still camera, a video camera, or other appropriate device positioned to capture the potential users of the presentation device.

At block 320, content computer 18 may process the received image to determine an indication of a relationship between the potential users. For example, in some implementations the content computer 18 may initially focus on one of the potential users and determine whether that potential user is related (e.g., socially) to any of the other potential users in the image, and may process other potential users in a similar manner until some or all of the possible relationships between the individuals in the image have been identified.

Content computer 18 may analyze a number of different factors, either alone or in appropriate combinations, to determine whether a relationship exists (or is likely to exist) between two or more potential users. Some examples of the different factors may include age, gender, ethnicity, body type, clothing, physical proximity to one another, the number of times the same individuals have been seen together (e.g., by the same or different cameras), and/or the level of engagement between the individuals.

Such factors, and others, may be used as inputs to a relationship analyzer that may be implemented with a rule set that defines what effect, if any, a particular factor or set of factors has on the determination of whether a relationship exists between individuals, and if so, what type of relationship it is likely to be. For example, content computer 18 may determine that a relationship exists (or is likely to exist) based in part on whether a personal attribute associated with one of the potential users is shared with or is complementary to a corresponding personal attribute associated with another of the potential users. As another example, content computer 18 may determine that a relationship exists (or is likely to exist) based in part on the physical distance between a body part of one of the potential users and a corresponding body part of another of the potential users.

At block 330, content computer 18 may select a targeted content item for playback based on the indication of the relationship. For example, content computer 18 may compare the indication of the relationship to targeting criteria associated with various available content items to generate a comparison result, and may select the targeted content item based on the comparison result.

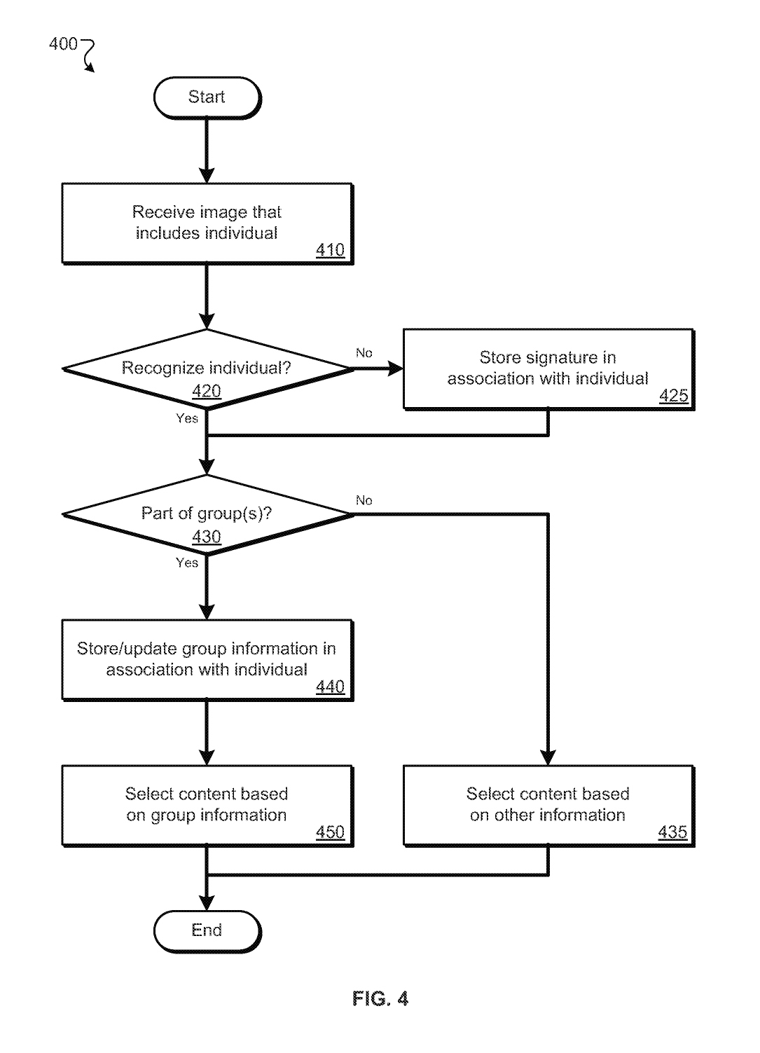

FIG. 4 is a flow diagram of an example process 400 for selecting targeted content based on relationships. The process 400 may be performed, for example, by a content computer such as the content computer 210 illustrated in FIG. 2. For clarity of presentation, the description that follows uses the content computer 210 illustrated in FIG. 2 as the basis of an example for describing the process. However, it should be understood that another system, or combination of systems, may be used to perform the process or various portions of the process.

Process 400 begins at block 410 when a computer system, such as content computer 210, receives an image that includes an individual, e.g., a potential user of a presentation device. The image may be received from an image capture device, such as a still camera, a video camera, or other appropriate device positioned to capture potential users of the presentation device.

At decision block 420, content computer 210 may determine whether it recognizes the individual. For example, content computer 210 may analyze a number of facial features associated with the individual to determine a digital signature associated with the individual. If the digital signature associated with the individual does not correspond to any known digital signatures, content computer 210 may store the digital signature in association with the individual at block 425. If the digital signature associated with the individual does correspond to a known digital signature, the content computer 210 may retrieve certain information associated with the individual.

At decision block 430, content computer 210 may determine whether the individual is associated with any groups. For example, in the case of either previously known or previously unknown individuals, content computer 210 may determine whether the received image shows any indication that the individual belongs to a group with other individuals included in the image. Such a determination may be based on a number of different factors associated with the individuals in the image such as age, gender, ethnicity, body type, clothing, physical proximity to one another, the number of times the same individuals have been seen together (e.g., by the same or different cameras), and/or the level of engagement between the individuals. In the case of previously known individuals, the content computer 210 may also retrieve any stored group information associated with the individual.

At block 435, if content computer 210 determines that the individual is not associated with any groups (either previously known groups or current groups), content computer 210 may select content for playback based on non-group information. For example, content computer 210 may select content for playback that is generic to the particular location or time, or may select content for playback that is targeted to the individual specifically rather than to a group to which the individual belongs.

If content computer 210 determines that the individual is associated with a group, e.g., based on an indication in the received image, content computer may store or update the group information in association with the individual at block 440. For example, content computer 210 may store any new group relationships that have been determined from the received image, and may update previously known group relationships if the received image contains any indications that such stored group relationships should be changed.

At block 450, content computer 210 may select content for playback based on the group information. For example, content computer 210 may compare the group information to targeting criteria associated with various available content items to generate a comparison result, and may select the targeted content based on the comparison result.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

1. A method for selecting a targeted content item for playback, the method comprising:
receiving, at a computer system and from an image capture device, an image that includes a plurality of potential users of a presentation device;
processing the image, using the computer system, to determine an indication of a relationship between two or more of the plurality of potential users;
selecting, using the computer system, a targeted content item for playback on the presentation device based on the indication of the relationship; and
detecting whether one or more of, but fewer than all of, the potential users who form the relationship are in proximity to the presentation device.

2. The method of claim 1, wherein processing the image to determine the indication of the relationship comprises determining whether a personal attribute associated with one of the potential users is shared with or is complementary to a corresponding personal attribute associated with another of the potential users.

3. The method of claim 1, wherein processing the image to determine the indication of the relationship comprises determining a physical distance between a body part of one of the potential users and a corresponding body part of another of the potential users.

4. The method of claim 1, wherein selecting the targeted content item comprises comparing the indication of the relationship to targeting criteria associated with a collection of content items to generate a comparison result, and selecting the targeted content item from the collection of content items based on the comparison result.

5. The method of claim 1, wherein selecting the targeted content item is further based on an extrinsic attribute, wherein the extrinsic attribute is at least one of a time of day, a date, a location of the presentation device, and an environmental parameter.

6. The method of claim 1, further comprising storing the indication of the relationship in association with the potential users who form the relationship.

7. The method of claim 6, further comprising retrieving the stored indication of the relationship, and selecting a second targeted content item for playback on the presentation device based on the stored indication of the relationship and the potential users who form the relationship who are not in proximity to the presentation device.

8. The method of claim 7, wherein the targeted content item is different from the second targeted content item.

9. A system for selecting targeted content, the system comprising:
a presentation device to display content to an audience;
an image capture device to capture an image of the audience that includes a potential viewer of the presentation device;
a group detection engine, executing on a processor, to determine group information from the image, the group information including an indication of a relationship between the potential viewer and other individuals included in the image;
a content selection engine, executing on a processor, to select targeted content for display on the presentation device based on the group information; and
the system to detect whether one or more of, but fewer than all of, the potential viewers and other individuals who form the relationship are in proximity to the presentation device.

10. The system of claim 9, wherein the group detection engine determines group information from the image based on whether a personal attribute associated with the potential viewer is shared with or is complementary to a corresponding personal attribute associated with one or more of the other individuals included in the image.

11. The system of claim 9, wherein the group detection engine determines group information from the image based on a physical distance between a body part of the potential viewer and a corresponding body part of one or more of the other individuals included in the image.

12. The system of claim 9, wherein the content selection engine compares the group information to targeting criteria associated with a plurality of content items to generate a comparison result, and selects the targeted content from the plurality of content items based on the comparison result.

13. The system of claim 9, further comprising an extrinsic attribute detector to determine an extrinsic attribute, and wherein the content selection engine selects the targeted content further based on the extrinsic attribute, wherein the extrinsic attribute is at least one of a day, a date, a location of the presentation device, and an environmental parameter.

14. The system of claim 9, further comprising a data store to store the group information in association with the potential viewer and the other individuals included in the image that form the relationship.

15. A non-transitory computer-readable storage medium storing instructions that, when executed by a processor, cause the processor to:
receive an image that includes a plurality of potential users of a presentation device;
process the image to determine a group to which two or more of the plurality of potential users belong;
select a targeted content item for playback on the presentation device based on the group; and
identify whether one or more of, but fewer than all of, the potential users who form the group are in proximity to the presentation device.
